(19) United States
(12) Patent Application Publication
(10) Pub. No.: US 2026/0340948 A1
(43) Pub. Date: Oct. 29, 2026

(54) VIRTUAL SPACE MANAGEMENT APPARATUS

(71) Applicant: NTT DOCOMO, INC., Tokyo (JP)

(72) Inventors: Tooru MATSUNAGA, Chiyoda-ku (JP); Naomasa YOSHIDA, Chiyoda-ku (JP); Jiro NEGISHI, Chiyoda-ku (JP); Yohei SATO, Chiyoda-ku (JP)

(73) Assignee: NTT DOCOMO, INC., Tokyo (JP)

(21) Appl. No.: 19/118,393

(22) PCT Filed: Sep. 1, 2023
(86) PCT No.: PCT/JP2023/032154

§ 371 Date: Apr. 4, 2025

(30) Foreign Application Priority Data
Oct. 19, 2022 (JP) 2022-167576

(51) Int. Cl. G06T 19/00

(52) U.S. Cl. CPC G06T 19/00; G06T 2219/024

(57) ABSTRACT

A virtual space server includes: a detector that detects a topic for each of a plurality of communities formed through conversation of two or more avatars present in a virtual space; a specifier that specifies a destination community from among the plurality of communities based on a degree of similarity between an interest of a yet-to-be-engaged avatar, which is an avatar that has not participated in any of the plurality of communities, and the topic for each of the plurality of communities; and a transferer that instantaneously transfers the yet-to-be-engaged avatar to an area where the yet-to-be-engaged avatar may converse with the two or more avatars belonging to the destination community.

### TECHNICAL FIELD

The present invention relates to virtual space management apparatuses.

### BACKGROUND ART

A computer system described in Patent Document 1 includes a transfer module and a conversion module. The transfer module is configured to complete a transfer protocol with an external virtual worlds server. The conversion module converts characteristics associated with the avatar based on one or more conversion rules associated with the virtual worlds server. The computer system additionally includes an interaction module configured to engage the avatar for interaction with one or more worlds on the virtual worlds server. According to this computer system, an avatar can be instantaneously transferred between one virtual space and another virtual space.

### RELATED ART DOCUMENT

### Patent Document

### Patent Document 1

Japanese Translation of PCT International Application Publication No. JP-T-2014-529792

### SUMMARY OF THE INVENTION

### Problem to be Solved by the Invention

In the virtual space, a large number of avatars that are strangers to the user are active. Even if an avatar can be instantaneously transferred to a virtual space, it is not easy for the avatar of a user to find an opportunity for communication, such as conversation with a stranger avatar in the virtual space.

An object of the present disclosure is to provide a virtual space management apparatus that promotes communication between avatars in a virtual space.

### Means of Solving the Problem

A virtual space management apparatus according to the present disclosure includes: a detector configured to detect a topic for each of a plurality of communities, each of which is formed through conversation of two or more avatars present in a virtual space; a specifier configured to specify a destination community from among the plurality of communities, based on a degree of similarity between an interest of a yet-to-be-engaged avatar and the topic for each of the plurality of communities, wherein the yet-to-be-engaged avatar is an avatar that has not participated in any of the plurality of communities; and a transferer configured to instantaneously transfer the yet-to-be-engaged avatar to an area in which the yet-to-be-engaged avatar can converse with the two or more avatars belonging to the destination community.

### Effect of the Invention

According to the present disclosure, since the yet-to-be-engaged avatar is instantaneously transferred to a community that is taking up a topic related to the interest of the yet-to-be-engaged avatar, communication between avatars is promoted in a virtual space.

### BRIEF DESCRIPTION OF THE DRAWINGS

FIG. 1 is a block diagram showing an overall configuration of a virtual space system 1 according to a first embodiment.

FIG. 2 is an explanatory diagram illustrating an example of a community.

FIG. 3 is a block diagram illustrating an example configuration of a virtual space server 10A.

FIG. 4 is an explanatory diagram illustrating an example data structure of a first table TBL1.

FIG. 5 is an explanatory diagram illustrating an example data structure of a second table TBL2.

FIG. 6 is an explanatory diagram showing an example of a yet-to-be-engaged avatar in a virtual space.

FIG. 7 is an explanatory diagram showing an example of instantaneous transfer of the yet-to-be-engaged avatar.

FIG. 8 is a block diagram showing a configuration example of a user apparatus 20[k].

FIG. 9 is a flowchart showing an example operation of the virtual space server 10A.

FIG. 10 is a flowchart showing detailed operations in step S14 of the virtual space server 10A.

FIG. 11 is a block diagram illustrating an example configuration of a virtual space server 10B according to a second embodiment.

FIG. 12A is an explanatory diagram illustrating an example data structure of a third table TBL3.

FIG. 12B is an explanatory diagram illustrating an example data structure of a fourth table TBL4.

FIG. 13 is an explanatory diagram for describing an example of a specific area.

FIG. 14 is a flowchart showing an example operation of the virtual space server 10B.

FIG. 15 is an explanatory diagram showing an example data structure of a second table TBL2 according to a second modification.

FIG. 16 is an explanatory diagram showing an example data structure of a first table TBL1 according to a fourth modification.

### MODES FOR CARRYING OUT THE INVENTION

### 1: Embodiments

In the following, a virtual space system 1 will be described with reference to the drawings.

### 1. First Embodiment

### 1.1: Configuration of First Embodiment

### 1.1.1: Overall Configuration

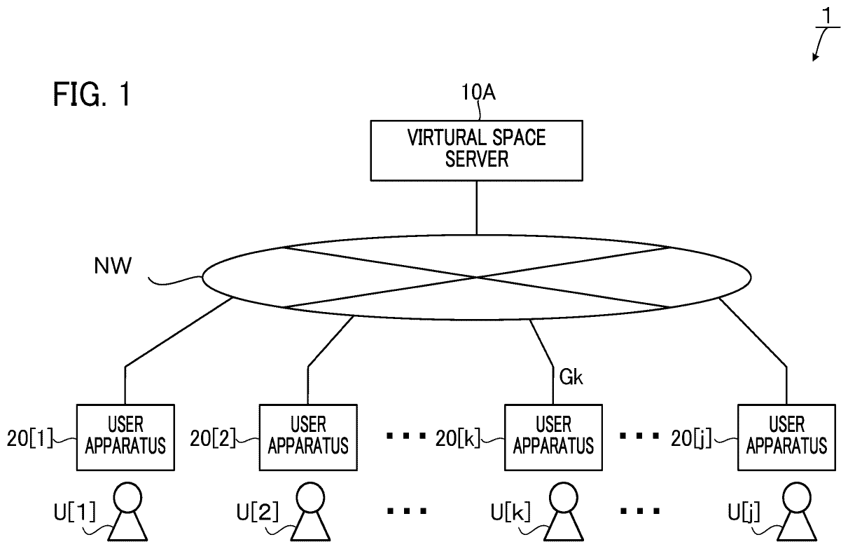

FIG. 1 is a block diagram illustrating an overall configuration of a virtual space system 1 according to a first embodiment. As shown in FIG. 1, the virtual space system 1 includes a virtual space server 10A and user apparatuses 20[1], 20[2], . . . 20[k], . . . 20[j]. The letter k is a freely chosen integer from 1 to j, inclusive. The user apparatuses 20[1], 20[2], . . . 20[k], . . . 20[j] are used by users U[1], U[2], . . . . U[k], . . . . U[j]. The virtual space servers 10A are communicably connected to the user apparatuses 20[1], 20[2], . . . 20[j] via a communication network NW.

The user apparatus 20[k] is constituted by an information processing device having a function of displaying images, and is, for example, a personal computer, a tablet terminal, a smartphone, or a head-mounted display. The user apparatus 20[k] may be configured as a combination of a tablet terminal, a smartphone, and a head-mounted display.

In a case in which the user apparatus 20[k] includes a head-mounted display, the user apparatus 20[k] provides an image to the user U[k] indicating a part of the three-dimensional virtual space. In a case in which the user apparatus 20[k] does not include a head-mounted display, the user apparatus 20[k] provides to the user U[k] an image indicating a part of the two-dimensional virtual space.

The virtual space server 10A provides a virtual space service. The virtual space server 10A is an example of a virtual space management apparatus. The user U[k] is subscribed to the virtual space service. In the virtual space service, an avatar used by the user U[k] can move within the virtual space. The avatar can also communicate with other avatars, such as through conversations. An avatar is a character used as the user's figure in a virtual space. The virtual space refers to the entire space that can be provided by the virtual space service. A space visually recognizable by an avatar is a part of the virtual space.

In the following description, a group of two or more avatars that are interested in a common topic and exchange messages is referred to as a community. A community in a virtual space is established by two or more avatars engaging in conversation. A community is synonymous with a group in which two or more avatars converse with each other. In the virtual space, a large number of avatars are active. Therefore, in the virtual space, a community emerges and disappears. A community emerges when avatars meet and converse with each other in a virtual space. A community disappears when the avatars stop engaging in conversation.

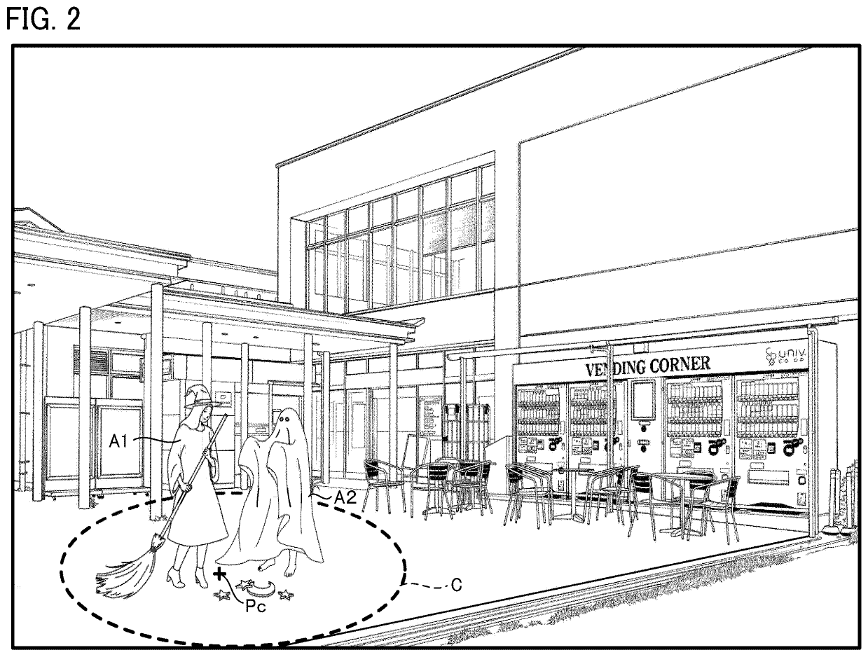

FIG. 2 is an explanatory diagram illustrating an example of a community. In this case, a community is established through conversation between an avatar A1 and an avatar A2.

The virtual space server 10A manages a plurality of communities existing in the virtual space in real time. The virtual space server 10A identifies each of the plurality of communities in the virtual space. The virtual space server 10A manages community-related items. The managed items include, for each of the plurality of communities, two or more avatars belonging to the community, a topic, and a location in a virtual space. In the virtual space, there is an avatar that has not yet participated in any community (hereinafter, “a yet-to-be-engaged avatar”). The virtual space server 10A has a function of instantaneously transferring such a yet-to-be-engaged avatar to the vicinity of a community that engages in a topic of the yet-to-be-engaged avatar's interest, from among the plurality of communities.

### 1.1.2: Configuration of Virtual Space Server 10A

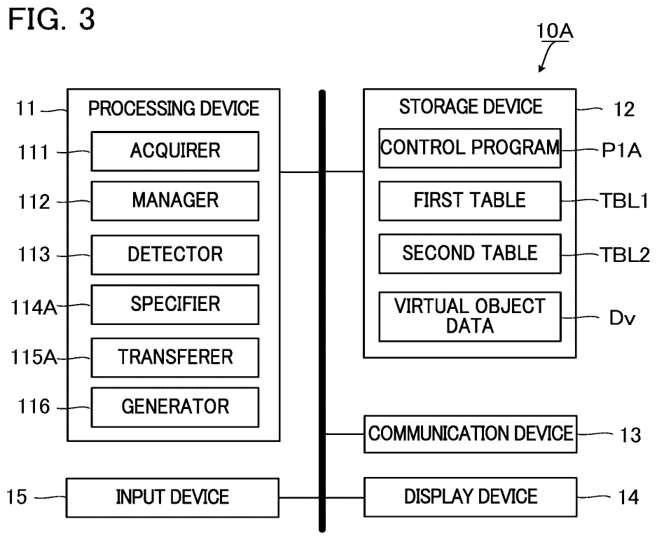

FIG. 3 is a diagram illustrating an example configuration of the virtual space server 10A. As shown in FIG. 3, the virtual space server 10A includes a processing device 11, a storage device 12, a communication device 13, a display device 14, and an input device 15. The elements of the virtual space server 10A are connected to each other by a single bus or by a plurality of buses, for communicating information. It is to be noted that the term “apparatus” in this specification may be replaced with other terms such as circuit, device, or unit.

The processing device 11 is a processor that controls the entire virtual space server 10A. The processing device 11 is constituted using, for example, one chip or multiple chips. The processing device 11 is constituted using, for example, a central processing unit (CPU: Central Processing Unit) including an interface with a peripheral device, an arithmetic unit, a register, and the like. It is to be noted that one, some, or all of the functions of the processing device 11 may be realized by hardware such as a DSP (Digital Signal Processor), an ASIC (Application Specific Integrated Circuit), a PLD (Programmable Logic Device), and an FPGA (Field Programmable Gate Array). The processing device 11 executes various processes in parallel or sequentially.

The storage device 12 is a recording medium readable and writable by the processing device 11. The storage device 12 includes, for example, a non-volatile memory and a volatile memory. Non-volatile memories are, for example, a ROM (Read Only Memory), an EPROM (Erasable Programmable Read Only Memory), and an EEPROM (Electrically Erasable Programmable Read Only Memory). The volatile memory is, for example, a RAM (Random Access Memory). The storage device 12 stores various types of data including a control program PIA executed by the processing device 11, a first table TBL1, a second table TBL2, and virtual object data Dv. The storage device 12 functions as a work area of the processing device 11. The virtual object data Dv represents virtual objects in three dimensions. The virtual objects include movable objects, such as avatars and vehicles that move in the virtual space, and fixed objects, such as buildings, that do not move in the virtual space.

The communication device 13 is hardware as a transmitting and receiving device (transceiver) for communicating with other apparatuses. The communication device 13 is also referred to as, for example, a network device, a network controller, a network card, a communication module, or the like. The communication device 13 may include a connector for wired connection and a wireless communication interface. Connectors and interface circuitry for wired connection include those compliant with wired LAN, IEEE1394, USB. Examples of the wireless communication interface include wireless LAN and Bluetooth (registered trademark).

The display device 14 is a device that displays images. The display device 14 displays various images under control of the processing device 11.

The input device 15 is a device for receiving an input operation of an administrator of the server. The input device 15 outputs an operation signal corresponding to the operation of the administrator to the processing device 11. The input device 15 includes, for example, a keyboard and a pointing device.

In the above configuration, the processing device 11 reads the control program PIA from the storage device 12. The processing device 11 functions as an acquirer 111, a manager 112, a detector 113, a specifier 114A, a transferer 115A, and a generator 116 by executing the read control program PIA.

The acquirer 111 acquires voice data transmitted from the user apparatuses 20[1], 20[2], . . . 20[j] via the communication device 13. The voice data indicates the content of the conversation of the community.

The manager 112 manages the first table TBL1 and the second table TBL2.

The first table TBL1 stores information about a user signed in the virtual space service. The first table TBL1 stores a user identifier UID (hereinafter, referred to as “UID”) for identifying a user, an avatar identifier AID (hereinafter, referred to as “AID”) for identifying an avatar used by the user, a location of the avatar in the virtual space, attributes of the user, and an action history of the avatar, in association with each other. The attributes of the user include one or more of gender, age, hobby, address, occupation, and work location. The UIDs stored in the first table TBL1 are limited to those UID corresponding to users who are signed in to the virtual space service.

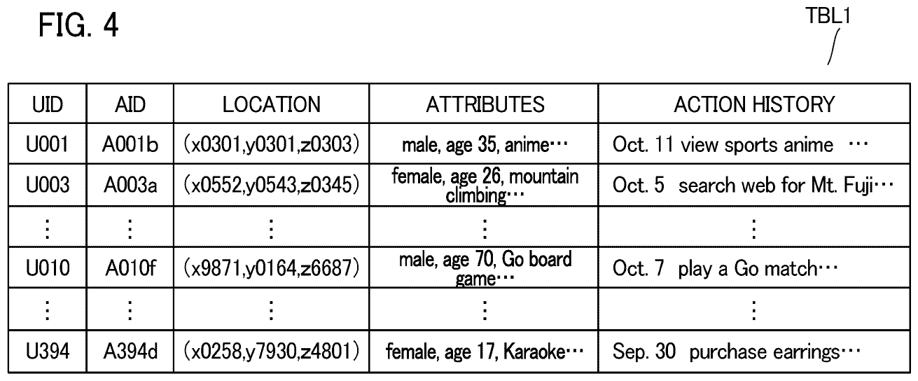

FIG. 4 is an explanatory diagram illustrating an example data structure of the first table TBL1. By referring to the first table TBL1, the processing device 11 can find where the avatar of each user who is signed in the virtual space service is located in the virtual space. According to the first table TBL1 shown in FIG. 4, the user with the UID, “U001”, is currently signed in, the AID of the avatar used by the user is “A001b”, and this avatar is located at (x0301, y0301, z0303).

The second table TBL2 manages communities existing in the virtual space in real time. The second table TBL2 stores, in association with each other, a community identifier (hereinafter referred to as “CID”) for identifying a community, an AID corresponding to each avatar belonging to the community, a location of the community, and a topic of the community. The location of the community is a center location of a plurality of avatars belonging to the community. As described above, a community emerges when two or more avatars converse, and disappears if the avatars stop engaging in the conversation. In the second table TBL2, a record is stored for each community. When a community disappears, the manager 112 removes the record, corresponding to the community that has disappeared, from the second table TBL2.

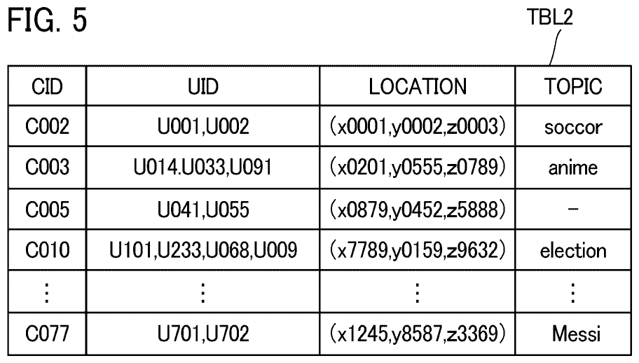

FIG. 5 is an explanatory diagram illustrating an example data structure of the second table TBL2. By referring to the second table TBL2, the processing device 11 can find the topics of the respective communities existing in the virtual space. According to the second table TBL2 shown in FIG. 5, soccer is the current topic in the community with the CID, “C002”.

The detector 113 shown in FIG. 3 detects a topic for each of a plurality of communities that has been formed through conversation between two or more avatars existing in the virtual space. For example, if there are 100 communities in the virtual space, topics are detected for each of the communities. As a result, the detector 113 detects 100 topics corresponding one-to-one with the 100 communities.

Specifically, the detector 113 detects a topic for each community by analyzing voice data for the community. The voice data is analyzed by using morphological element analysis, for example. The detector 113 may detect the topic of the community based on the frequency of a term, extracted through morphological element analysis, appearing in the conversation. The topic detected by the detector 113 is stored in the second table TBL2 by the manager 112. The detector 113 may detect topics in parallel for some or all of the plurality of communities.

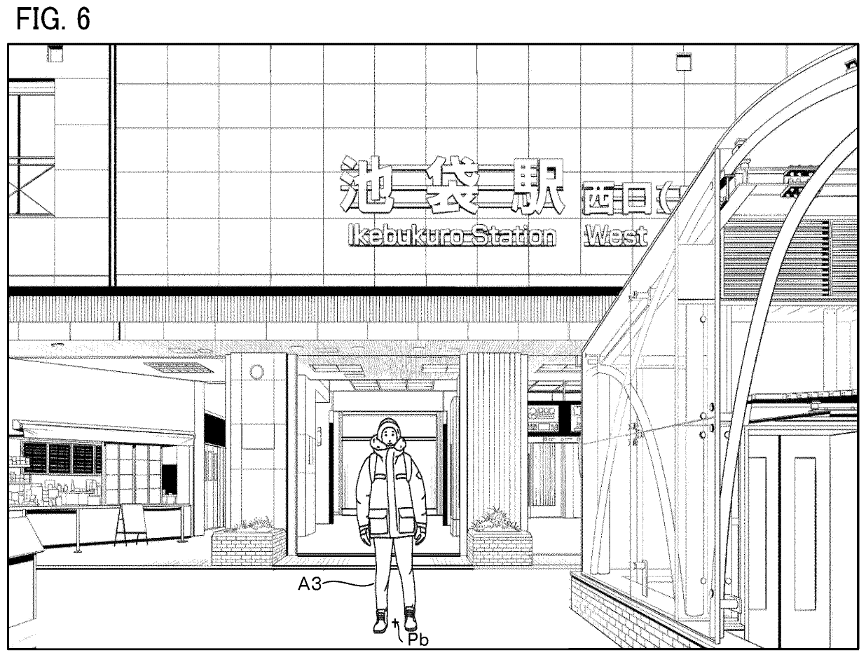

The specifier 114A specifies a destination community from among the plurality of communities based on the interests of the yet-to-be-engaged avatar, which is an avatar that has not participated in any of the plurality of communities in the virtual space, and the topic in each of the plurality of communities. A user who has just signed in to the virtual space service enters the virtual space using the user's avatar. In this state, the avatar of the user has not participated in any of the plurality of communities, and thus, is a yet-to-be-engaged avatar. FIG. 6 is an explanatory diagram illustrating an example of a yet-to-be-engaged avatar. The avatar A3 shown in FIG. 6 is not currently in conversation with another avatar. Therefore, the avatar A3 is a yet-to-be-engaged avatar.

The specifier 114A refers to the first table TBL1 and the second table TBL2, to specify a yet-to-be-engaged avatar. Specifically, the specifier 114A extracts, from among AIDs recorded in the first table TBL1, an AID that is not recorded in the second table TBL2. The extracted AID corresponds to the yet-to-be-engaged avatar.

The specifier 114A refers to the first table TBL1, to extract the attributes of a user that corresponds to the extracted AID of the yet-to-be-engaged avatar, and the action history of the yet-to-be-engaged avatar. In addition, the specifier 114A specifies the interests of the yet-to-be-engaged avatar based on the extracted user attributes of the yet-to-be-engaged avatar, the extracted action history of the yet-to-be-engaged avatar, or both of the extracted user attributes of the yet-to-be-engaged avatar and the extracted action history of the yet-to-be-engaged avatar.

The specifier 114A extracts a topic for each of the plurality of communities by referring to the second table TBL2. The specifier 114A calculates a degree of similarity between the interests of the yet-to-be-engaged avatar and the topic for each of the plurality of communities. The degree of similarity indicates a degree of similarity between the interests and the topics. In a case in which the number of the plurality of communities is N, the specifier 114A calculates N similarity degrees. Here, N is an integer of 2 or more. The specifier 114A specifies a destination community among the plurality of communities based on the similarity degrees.

More specifically, the specifier 114A specifies a community with the highest degree of similarity from among the plurality of communities, as a candidate community that is a candidate as the destination of the yet-to-be-engaged avatar. The specifier 114A presents situations of the candidate community to the yet-to-be-engaged avatar. The situations of the candidate community may include, for example, the topic of the candidate community, the location of the candidate community, the number of avatars belonging to the candidate community, or the time since the candidate community emerged. The specifier 114A specifies the candidate community as the destination community in a case in which the yet-to-be-engaged avatar is allowed to participate in the candidate community.

The transferer 115A instantaneously transfers the yet-to-be-engaged avatar to an area where conversations with two or more avatars belonging to the destination community can be performed. Specifically, the transferer 115A refers to the second table TBL2 to acquire the location of the community associated with the CID of the destination community specified by the specifier 114A. The transferer 115A specifies an area having a predetermined radius centered on the location of the community, as an area in which conversation can take place. In this area, the transferred avatar can converse with two or more avatars belonging to the destination community. The transferer 115A transfers the yet-to-be-engaged avatar to the area in which conversation can take place.

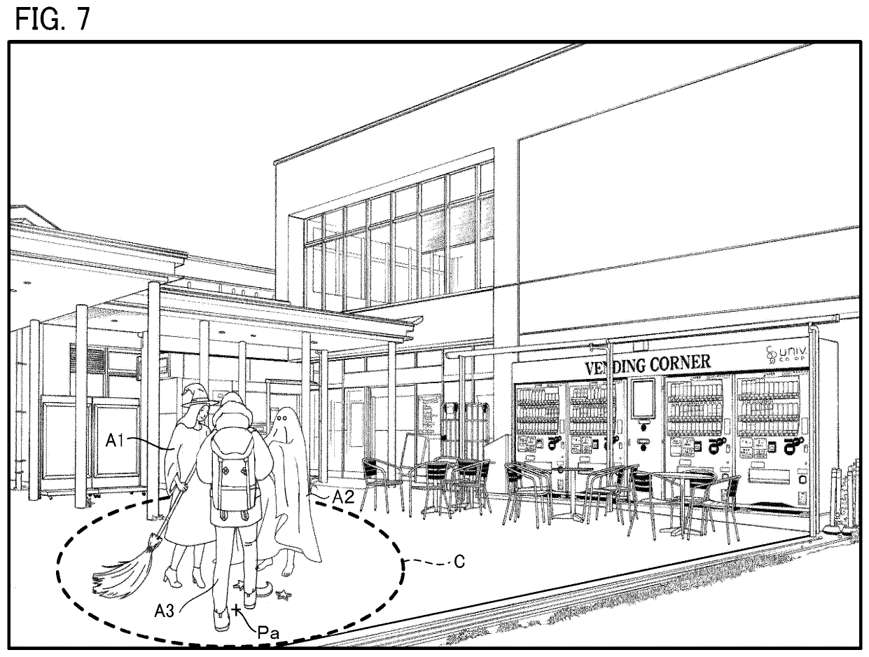

For example, in the community shown in FIG. 2, a location Pc indicates the location of the community. An area C is an area in which conversation can take place. If the degree of similarity between the interest of the yet-to-be-engaged avatar A3 shown in FIG. 6 and the topic of the community shown in FIG. 2 is highest, the yet-to-be-engaged avatar A3 instantaneously transfers from the location Pb shown in FIG. 6 to the area C shown in FIG. 2. Consequently, as shown in FIG. 7, the yet-to-be-engaged avatar A3 instantaneously transfers to the location Pa in the area C.

In this case, it is preferable that the transferer 115A instantaneously transfer the yet-to-be-engaged avatar to a location in an area in which conversation can take place and that does not overlap the locations of two or more avatars belonging to the destination community.

The transferer 115A further measures an elapsed time since the yet-to-be-engaged avatar joined the destination community, and in response to the elapsed time reaching a reference time (reference time length), instantaneously transfers the yet-to-be-engaged avatar from a first location in an area in which conversation can take place to a second location outside the an area in which conversation can take place. The reference time is, for example, 5 minutes. By limiting the duration in which the yet-to-be-engaged avatar is engaged in the destination community, if the yet-to-be-engaged avatar does not fit in with the destination community, the yet-to-be-engaged avatar can easily leave the destination community. For example, the yet-to-be-engaged avatar A3 shown in FIG. 7 instantaneously transfers from the location Pa in the area C to the location Pb shown in FIG. 6 when the elapsed time reaches the reference time. The location Pa is an example of the first location, and the location Pb is an example of the second location. By returning to a previous location before the instantaneous transfer in such a manner, the yet-to-be-engaged avatar A3 can resume activities that were scheduled prior to participating in the community.

The generator 116 shown in FIG. 3 generates image data indicating an image of the virtual space on the basis of the virtual object data Dv and avatar data associated with the movements of the avatars received from the user apparatuses 20[1] to 20[j] via the communication device 13. The generator 116 transmits the image data to the user apparatuses 20[1] to 20[j] via the communication device 13.

### 1.1.3: Configuration of User Apparatus

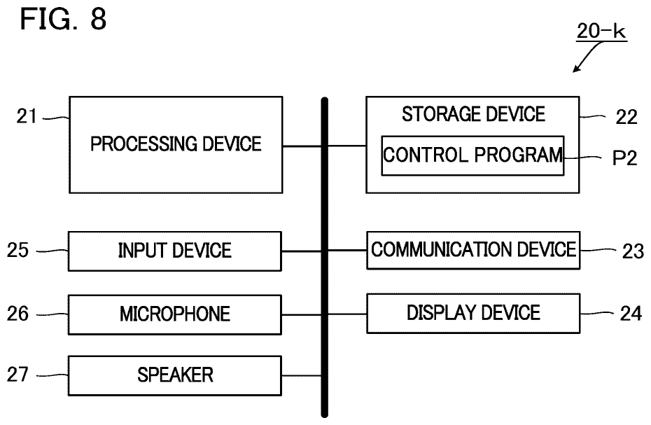

FIG. 8 is a block diagram illustrating a configuration example of the user apparatus 20[k]. The user apparatus 20[k] includes a processing device 21, a storage device 22, a communication device 23, a display device 24, an input device 25, a microphone 26, and a speaker 27. The respective elements of the user apparatus 20[k] are connected to each other by a single bus or by multiple buses for communicating information. The user apparatus 20[k] is an example of a display control apparatus.

The processing device 21 is a processor that controls the entire user apparatus 20[k]. The processing device 21 is constituted using, for example, a single chip or multiple chips. The processing device 21 is constituted using, for example, a central processing unit (CPU) including an interface with a peripheral device, an arithmetic unit, a register, or a similar device. One, some, or all of the functions of the processing device 21 may be realized by hardware such as a DSP, ASIC, PLD, FPGA. The processing device 21 executes various processes in parallel or sequentially.

The storage device 22 is a recording medium that can be read and written by the processing device 21. The storage device 22 stores a plurality of programs including a control program P2 executed by the processing device 21. The storage device 22 functions as a work area of the processing device 21.

The communication device 23 is hardware as a transmitting and receiving device (transceiver) for communicating with other devices. The communication device 23 is also referred to as, for example, a network device, a network controller, a network card, a communication module, or the like. The communication device 23 may include a connector for wired connection, and may include interface circuitry corresponding to the connector. The communication device 23 may include a wireless communication interface.

The display device 24 is a device that displays an image. The display device 24 displays various images under control of the processing device 21. In a case in which the user apparatus 20[k] is a head-mounted display, the display device 24 includes a display for the left eye and a display for the right eye. By displaying different images corresponding to the parallax on the two displays, the user U[k] can recognize a three-dimensional image.

The input device 25 is a device for receiving an input operation of the user U[k]. The input device 25 outputs an operation signal corresponding to the operation of the user U[k] to the processing device 21. The input device 25 is constituted by, for example, a touch panel. The input device 25 may include an image capture device. In a case in which the input device 25 includes the image capture device, the input device 25 detects a gesture of the user U[k] based on an image captured by the image capture device. The input device 25 outputs an operation signal indicating the detected gesture to the processing device 21.

The microphone 26 is a device that converts sound into electrical signals. The microphone 26 includes a DA converting device. The microphone 26 converts the sound based on speech of the user U[k] into a sound signal, and converts the sound signal into sound data using the DA converting device. The sound data is output to the processing device 21.

The speaker 27 is a device that converts an electrical signal into sound. The speaker 27 includes an AD converting device. The sound data output from the processing device 21 is converted into a sound signal by the AD converting device. The speaker 27 converts an input sound signal into a sound and emits the sound. The speaker 27 may be built in the earphones.

### 1.2: Operation of Virtual Space Server 10A

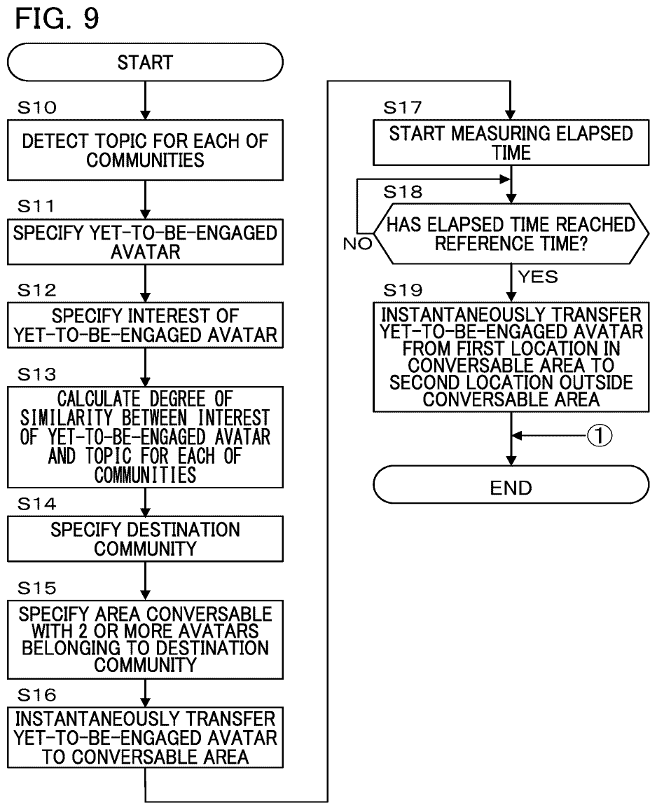

The operation of the virtual space server 10A will be described below. FIG. 9 is a flowchart illustrating an example operation of the virtual space server 10A.

At step S10, the processing device 11 detects a topic for each of a plurality of communities in the virtual space. The processing device 11 detects the topic for each community by analyzing voice data of each community. More specifically, the processing device 11 refers to the second table TBL2 to extract a community for which the topic is not recorded. The processing device 11 identifies a plurality of UIDs belonging to the extracted community. The processing device 11 detects the topic of the community based on voice data corresponding to the plurality of identified UIDs (that is, the voice data of the plurality of users belonging to the extracted community). The processing device 11 writes the detected topic into the second table TBL2. For example, in the second table TBL2 shown in FIG. 5, no topic is recorded in the record including the CID “C005”. Therefore, the processing device 11 detects the topic of the community corresponding to the CID “C005” based on the voice data of UID “U041” and UID “U055” that are recorded in the record.

At step S11 shown in FIG. 9, the processing device 11 specifies a yet-to-be-engaged avatar. The processing device 11 extracts, from among AIDs recorded in the first table TBL1, an AID not recorded in the second table TBL2. The extracted AID corresponds to the yet-to-be-engaged avatar. The yet-to-be-engaged avatar is specified based on the extracted AID.

At step S12, the processing device 11 specifies the interest of the yet-to-be-engaged avatar. The processing device 11 refers to the first table TBL1 to extract user attributes corresponding to the AID of the yet-to-be-engaged avatar and the action history of the yet-to-be-engaged avatar. The processing device 11 specifies the interest of the yet-to-be-engaged avatar based on the extracted user attributes of the yet-to-be-engaged avatar, the extracted action history of the yet-to-be-engaged avatar, or both. For example, in the record including the AID “A003a” in the first table TBL1 shown in FIG. 4, “mountain climbing” is recorded in the attributes and “Mt. Fuji web search” is recorded in the action history. In a case in which the avatar with the AID “A003a” is a yet-to-be-engaged avatar, the processing device 11 may specify the interest of the yet-to-be-engaged avatar as “climbing Mt. Fuji” based on the attribute of “mountain climbing” and the action history of “Mt. Fuji web search”.

At Step S13, the processing device 11 calculates a degree of similarity between the interest of the yet-to-be-engaged avatar and the topic for each of the plurality of communities. For example, cosine similarity can be used for this calculation.

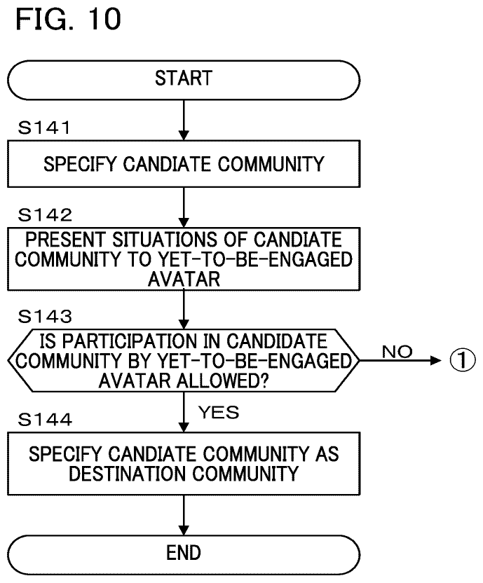

At step S14, the processing device 11 identifies the destination community based on the degree of similarity. FIG. 10 is a flowchart illustrating a detailed operation of the virtual space server 10A in step S14.

At step S141, the processing device 11 specifies a community having the highest degree of similarity, from among the plurality of communities, as a candidate community that is a candidate for the destination community for the yet-to-be-engaged avatar.

At step S142, the processing device 11 presents the situations of the candidate community to the yet-to-be-engaged avatar. For example, the processing device 11 reads a topic corresponding to the CID of the candidate community by referring to the second table TBL2. The processing device 11 generates a virtual object indicating the read topic. This virtual object is arranged at a location in the virtual space visually recognizable by the yet-to-be-engaged avatar. The processing device 11 transmits an image indicative of the generated virtual object to the user apparatus 20 used by a user corresponding to the yet-to-be-engaged avatar via the communication device 13. Accordingly, the user corresponding to the yet-to-be-engaged avatar can grasp the situations of the candidate community.

At step S143, the processing device 11 determines whether the yet-to-be-engaged avatar is allowed to participate in the candidate community based on the user's operation. For example, in a case in which the virtual object indicating the topic includes a button for inputting whether to allow participation, the processing device 11 determines whether the yet-to-be-engaged avatar is allowed to participate, based on the user's button pressing operation.

In a case in which the determination result of step S143 is affirmative, the processing device 11 advances the processing to step S144. At step S144, the processing device 11 specifies the candidate community as the destination community. On the other hand, if the determination result of step S143 is negative, the processing device 11 ends the processing.

Since the situations of the candidate community can be presented to the yet-to-be-engaged avatar, the yet-to-be-engaged avatar can determine whether to transfer instantaneously to the candidate community based on the situations of the candidate community.

At step S15 shown in FIG. 9, the processing device 11 specifies an area in which the yet-to-be-engaged avatar can converse with two or more avatars belonging to the destination community. The processing device 11 refers to the second table TBL2 to obtain the location of the community associated with the CID of the destination community. The processing device 11 specifies an area having a predetermined radius centered on the location of the community as an area in which conversation can take place in which the yet-to-be-engaged avatar will be able to converse with two or more avatars belonging to the destination community.

At step S16, the processing device 11 instantaneously transfers the yet-to-be-engaged avatar to the area in which conversation can take place.

At step S17, the processing device 11 starts measuring time elapsed since the yet-to-be-engaged avatar started participating in the destination community.

At step S18, the processing device 11 determines whether the elapsed time has reached the reference time. If the determination result is negative, the processing device 11 repeats the determination of step S18 until the determination result is affirmative. On the other hand, if the determination result is affirmative, the processing device 11 advances the processing to step S19.

At step S19, the processing device 11 instantaneously transfers the yet-to-be-engaged avatar from a first location within an area in which conversation can take place to a second location outside an area in which conversation can take place. The second location may be any location as long as it is a location where a conversation with two or more avatars belonging to the destination community can no longer be performed. For example, the second location may be a location immediately before the yet-to-be-engaged avatar instantaneously transferred at step S16. Alternatively, the second location may be a location predetermined by the user of the yet-to-be-engaged avatar. The location predetermined by the user may be, for example, a living room at home. In the above process, the processing device 11 functions as the detector 113 in step S10. The processing device 11 functions as the specifier 114A from step S11 to step S14. The processing device 11 functions as the transferer 115A from step S15 to step S19.

### 1.3: Effects of First Embodiment

As described above, the virtual space server 10A includes: a detector 113 that detects a topic for each of a plurality of communities formed by conversation of two or more avatars existing in a virtual space; a specifier 114A that specifies a destination community from among the plurality of communities based on a degree of similarity between (i) an interest of the yet-to-be-engaged avatar that is an avatar that has not participated in any of the plurality of communities and (ii) a topic for each of the plurality of communities; and a transferer 115A that instantaneously transfers the yet-to-be-engaged avatar to an area where the yet-to-be-engaged avatar can converse with two or more avatars belonging to the destination community.

Since the virtual space server 10A has the above configuration, the yet-to-be-engaged avatar can instantaneously transfer to a community that is highly similar to the interests of the avatar. Therefore, communication between avatars is promoted in a virtual space in which a large number of unspecified avatars are present.

The detector 113 detects a topic based on the content of a conversation of two or more avatars. The specifier 114A specifies the interests of a yet-to-be-engaged avatar based on the activity history of the yet-to-be-engaged avatar, the attributes of a user corresponding to the yet-to-be-engaged avatar, or both.

Since the detector 113 detects the topic of the community based on the content of the conversation of the two or more avatars, the topic is specified in accordance with the content actually discussed, as compared with a configuration in which a topic set in advance as the attribute of the community is the topic of the community. Therefore, when the yet-to-be-engaged avatar instantaneously transfers to the destination community, the yet-to-be-engaged avatar can smoothly participate in the conversation.

The specifier 114A presents to the yet-to-be-engaged avatar the situations of a candidate community for instantaneous transfer, from among a plurality of communities, and in a case in which the yet-to-be-engaged avatar is allowed to participate in the candidate community, the specifier 114A specifies the candidate community as the destination community.

Since the specifier 114A presents to the yet-to-be-engaged avatar the situations of the destination community for instantaneous transfer, the yet-to-be-engaged avatar is provided with resources necessary for determining whether to participate in the community. In addition, since the specifier 114A specifies the candidate community as the destination community based on the permission of the yet-to-be-engaged avatar, conversing with other avatars by the yet-to-be-engaged avatar in the destination community can be promoted.

The transferer 115A measures time elapsed since the yet-to-be-engaged avatar joined the destination community, and instantaneously transfers the yet-to-be-engaged avatar from the first location in the area to the second location outside the area in response to the elapsed time reaching the reference time.

Even if the yet-to-be-engaged avatar has participated in the destination community, the avatar may still find it difficult to engage in a conversation in the community. In a case which the yet-to-be-engaged avatar does not fit in with the destination community, the transferer 115A can cause the yet-to-be-engaged avatar leave the destination community by instantaneous transfer.

### 2. Second Embodiment

A virtual space system 1 according to the second embodiment is configured similarly to the virtual space system 1 according to the first embodiment, except that a virtual space server 10B is used in place of the virtual space server 10A. In the virtual space server 10A of the first embodiment, the permission of the yet-to-be-engaged avatar is required for the yet-to-be-engaged avatar to instantaneously transfer to the destination community. On the other hand, the virtual space server 10B according to the second embodiment instantaneously transfers the yet-to-be-engaged avatar to the destination community without requiring permission of the yet-to-be-engaged avatar.

That is, since the instantaneous transfer in the first embodiment is realized as a result of a user responding to the inquiry about the instantaneous transfer from the system, the transfer would not be surprising and would be less unexpected to the user of the yet-to-be-engaged avatar. On the other hand, the instantaneous transfer in the second embodiment takes place accidentally without requiring permission. Therefore, the instantaneous transfer in the second embodiment is highly unexpected and surprising for the user of the yet-to-be-engaged avatar.

The avatar activity in the virtual space has a greater degree of freedom than the activity of the user in the real world. In addition, the activity of the avatar in the virtual space does not have any restrictions such as an activity for the purpose of achieving a predetermined target like a game. For this reason, there are many users who would not find a target for the activity of the avatar in the virtual space. A user who does not find a target tends to feel bored in the virtual space.

The virtual space server 10B of the second embodiment provides a surprising, unexpected experience to the user and brings together avatars that have never been encountered before by generating accidental instantaneous transfers.

### 2.1: Configuration of Virtual Space Server 10B

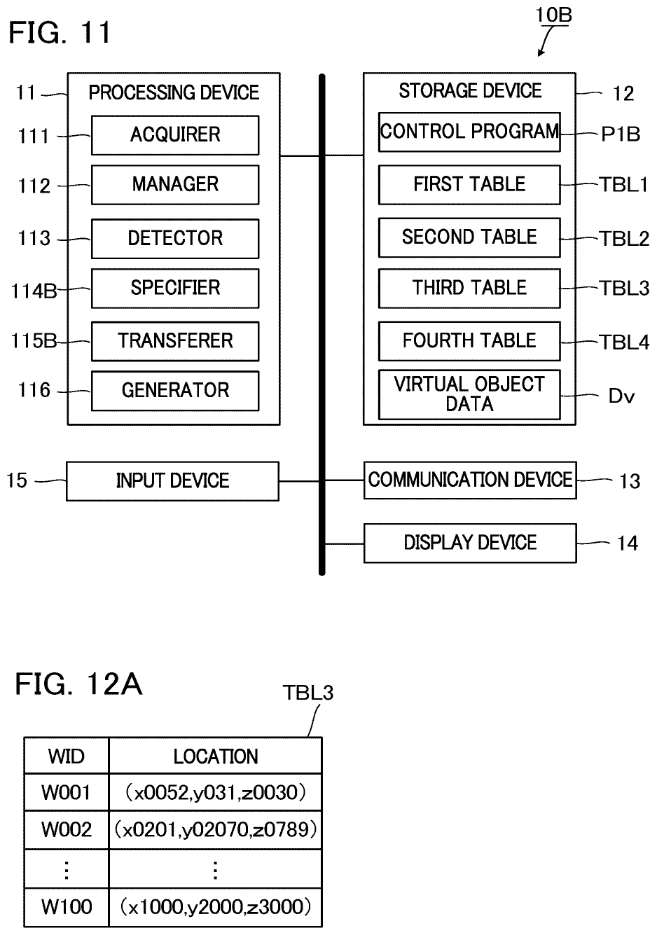

FIG. 11 is a diagram illustrating an example configuration of the virtual space server 10B according to the second embodiment. The virtual space server 10B shown in FIG. 11 has the same configuration as the virtual space server 10A shown in FIG. 3, except that a control program PIB is used in place of the control program PIA, a specifier 114B is used in place of the specifier 114A, a transferer 115B is used in place of the transferer 115A, and the storage device 12 stores a third table TBL3 and a fourth table TBL4.

The processing device 11 reads the control program PIB from the storage device 12. The processing device 11 functions as the acquirer 111, the manager 112, the detector 113, the specifier 114B, the transferer 115B, and the generator 116, through executing the read control program P1B.

The specifier 114B is the same as the specifier 114A in that it specifies a destination community based on the degree of similarity. However, the specifier 114B is different from the specifier 114A, which requires the permission of the yet-to-be-engaged avatar in specifying the destination community, in that the specifier 114B specifies the destination community without obtaining the permission of the yet-to-be-engaged avatar.

The specifier 114B specifies, as the destination community, a community with the highest degree of similarity from among the plurality of communities.

The transferer 115B is different from the transferer 115A in that the transferer 115B instantaneously transfers the yet-to-be-engaged avatar to the destination community in response to the yet-to-be-engaged avatar performing a predetermined action, whereas the yet-to-be-engaged avatar performing a predetermined action does not serve as a trigger for the transferer 115A to instantaneously transfer the yet-to-be-engaged avatar to the destination community.

Examples of the predetermined action may include, for example, that the yet-to-be-engaged avatar is located within a predetermined specific area while walking in the virtual space, and that the yet-to-be-engaged avatar has granted “Likes” to a virtual object in the virtual space. Granting “Likes” means giving a good evaluation of the virtual object. The virtual object to be evaluated corresponds to a commodity or a service to be traded in the virtual space. The transferer 115B may instantaneously transfer the yet-to-be-engaged avatar when “Likes” is granted to any one object from among all the objects in the virtual space. The transferer 115B may instantaneously transfer the yet-to-be-engaged avatar when “Likes” is granted to any one object from among one or some of the virtual objects in the virtual space. In the present example, it is assumed that the transferer 115B instantaneously transfers when “Likes” is granted for any one object from among some of the virtual objects in the virtual space.

A plurality of specific areas is set in the virtual space. In the third table TBL3 stored in the storage device 12, area identifiers WID for identifying the respective specific areas and the locations of the respective specific areas are stored in association with each other. Each of the specific areas of this example is in the shape of a circle and has a predetermined radius. The radius is, for example, 2 m. The location of the specific area corresponds to the location of the center of the circle. However, the shape of each of the plurality of specific areas is not limited to being circular, and it may be freely selected.

A plurality of object identifiers XID is stored in the fourth table TBL4, which is stored in the storage device 12. The plurality of object identifiers XID corresponds to a subset or subsets of objects from among a plurality of virtual objects present in the virtual space. When “Likes” is granted to any object from among these subsets of objects, the instantaneous transfer is triggered. An object identifier XID identifies each of the plurality of virtual objects present in the virtual space.

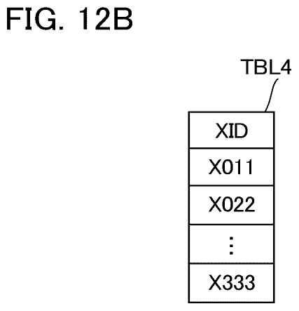

FIG. 12A is a diagram illustrating an example data structure of the third table TBL3. FIG. 12B is a diagram illustrating an example data structure of the fourth table TBL4. By referring to the third table TBL3, the transferer 115B can find where the specific area is located in the virtual space. By referring to the fourth table TBL4, the transferer 115B can find whether the virtual object to which the yet-to-be-engaged avatar has granted “Likes” is a virtual object that triggers the instantaneous transfer.

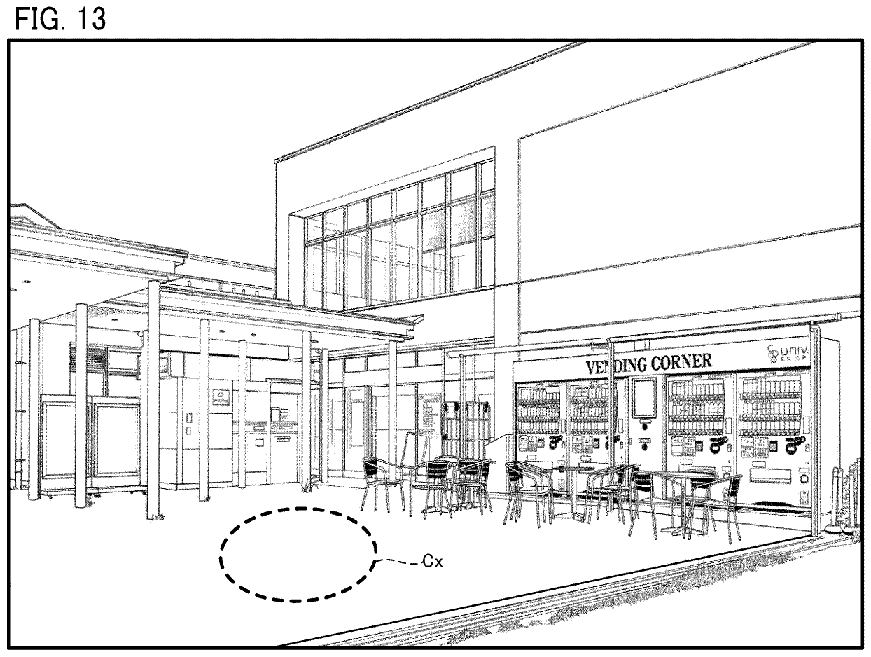

FIG. 13 is an explanatory diagram for explaining an example of the specific area. The area Cx shown in FIG. 13 is a specific area. In a case in which the yet-to-be-engaged avatar is located in the area Cx, an accidental instantaneous transfer may be performed. The area Cx can be considered as a virtual trap that the avatar cannot recognize.

The transferer 115B shown in FIG. 11 detects that the yet-to-be-engaged avatar is located in a specific area based on the location of the yet-to-be-engaged avatar and the location of the specific area. The transferer 115B detects, based on a motion of the yet-to-be-engaged avatar, that a virtual object to which the yet-to-be-engaged avatar has granted “Likes” is a virtual object that triggers the instantaneous transfer. When either one of the two types of detection results is obtained, the transferer 115B instantaneously transfers the yet-to-be-engaged avatar to the destination community.

### 2.2: Operation of Virtual Space Server 10B

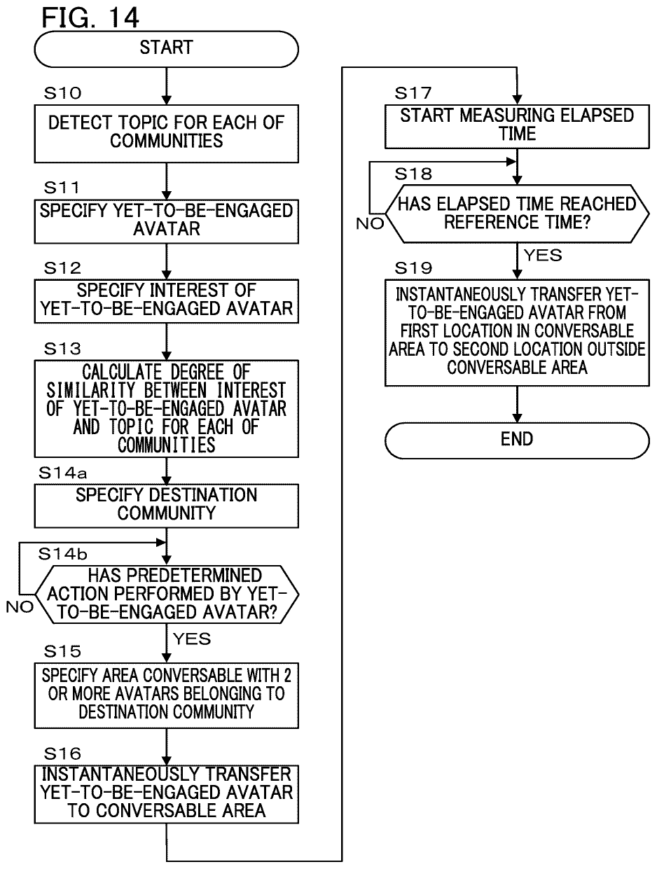

The operation of the virtual space server 10B will be described. FIG. 14 is a flowchart illustrating an example operation of the virtual space server 10B. The operation of the virtual space server 10B is similar to the operation of the virtual space server 10A shown in FIG. 9, except that step S14a and step S14b are added in place of step S14. In the following, step S14a and step S14b, which are different steps, will be described.

At step S14a, the processing device 11 specifies the destination community based on the degree of similarity. More specifically, the processing device 11 specifies, as the destination community, a community having the highest degree of similarity from among the plurality of communities in the virtual space. The processing device 11 specifies a CID of a community with the highest degree of similarity. The specified CID will be the CID of the destination community.

In S14b, the processing device 11 determines whether the yet-to-be-engaged avatar has performed the predetermined action. In a case in which the determination result of step 14b is negative, the processing device 11 repeats the determination of step 14b. On the other hand, in a case in which the determination result of step 14b is affirmative, the processing device 11 advances the processing to step S15.

In the above process, the processing device 11 functions as the detector 113 in step S10. The processing device 11 functions as the specifier 114B from step S11 to step S14a. The processing device 11 functions as the transferer 115B from step S14b to step S19.

### 2.3: Effects of Second Embodiment

The virtual space server 10B includes the transferer 115B. The transferer 115B instantaneously transfers the yet-to-be-engaged avatar to the destination community in response to the yet-to-be-engaged avatar taking a predetermined action.

According to the above configuration, the virtual space server 10B can provide a surprising, unexpected experience to the user through generation of accidental instantaneous transfers. As a result, a virtual space service that does not bore the user is provided. Also, by bringing together avatars that have never been encountered before, communication between the avatars is promoted.

### 3. Modifications

The present disclosure is not limited to the embodiments illustrated above. Specific variations are exemplified below. Two or more embodiments optionally selected from the following examples may be combined.

### 3.1: Modification 1

In the first embodiment and the second embodiment described above, the respective virtual space servers 10A and 10B generate an image of the virtual space and transmits the generated image to the user apparatus 20[k], but the present disclosure is not limited thereto. The virtual space servers 10A and 10B manage the location of the avatar of the user U[k] by using the first table TBL1. The virtual space servers 10A and 10B may transmit data associated with a fixed virtual object arranged in the virtual space around the location of the avatar to the user apparatus 20[k] in advance, and then transmit to the user apparatus 20[k] an image of a virtual object, a location of which moves, such as the avatar or the like. The user apparatus 20[k] manages an image associated with a fixed virtual object and an image associated with a movable virtual object at different layers. Furthermore, the user apparatus 20[k] may generate an image in which the layers are mutually superimposed, and display the generated image on the display device 24. The virtual space servers 10A and 10B transmit images managed in layers, through which communication resources can be saved.

### 3.2: Modification 2

In the first embodiment and the second embodiment described above, the detector 113 detects topics of a plurality of communities, to store the detected topics in the second table TBL2. The detector 113 according to Modification 2 updates a topic stored in the second table TBL2 as needed, and stores the updated time at which the topic is updated in the second table TBL2.

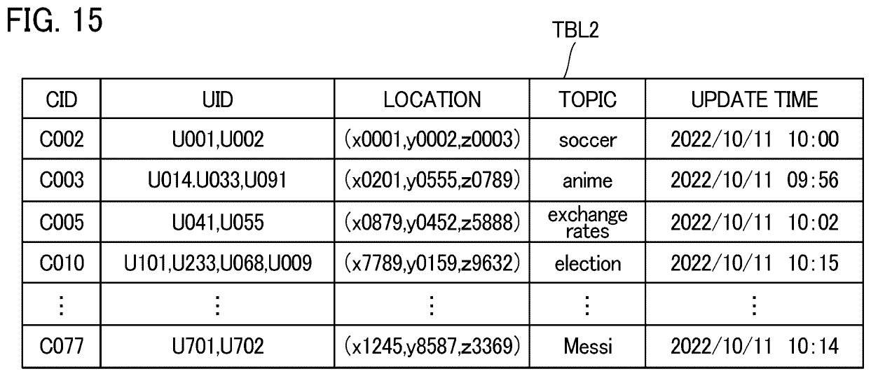

FIG. 15 is an explanatory diagram illustrating an example data structure of a second table TBL2 according to Modification 2. The detector 113 refers to the second table TBL2 and detects, with the highest priority, the topic of the community for which the topic is not stored. When the topics are stored for all the communities managed by the second table TBL2, the detector 113 detects the respective topics again in ascending order of update times. The content of conversations in a community changes over time. By detecting topics in ascending order of update times, the degree of similarity between newer topics and the interest of yet-to-be-engaged avatars is calculated. Therefore, compared with a case in which the topic is not updated, the yet-to-be-engaged avatar can smoothly participate in the conversation when the yet-to-be-engaged avatar transfers to the destination community.

### 3.3: Modification 3

In the above-described first embodiment, when the yet-to-be-engaged avatar is instantaneously transferred to a community, the permission of the yet-to-be-engaged avatar is set as the condition of the instantaneous transfer. The present disclosure is not limited thereto. That is, the instantaneous transfer may be performed without obtaining permission from the yet-to-be-engaged avatar.

### 3.4: Modification 4

In the above-described second embodiment, when a yet-to-be-engaged avatar performs a predetermined action, the yet-to-be-engaged avatar is forced to instantaneously transfer to the destination community. However, there may be a case in which the yet-to-be-engaged avatar is scheduled in the virtual space. In addition, when a user signs in the virtual space service, the user may sign in with some purpose, such as aiming for an experience in the virtual space. When there is such a schedule or purpose, it is desirable to avoid forced instantaneous transfer.

Therefore, it may be configured so that the user can input whether to allow forced instantaneous transfer. Specifically, the user apparatus 20[k] transmits to the virtual space server 10B control data Dc input by the user U[k], the control data Dc indicating whether to allow the forced instantaneous transfer. The manager 112 of the virtual space server 10B stores the control data Dc in the first table TBL1.

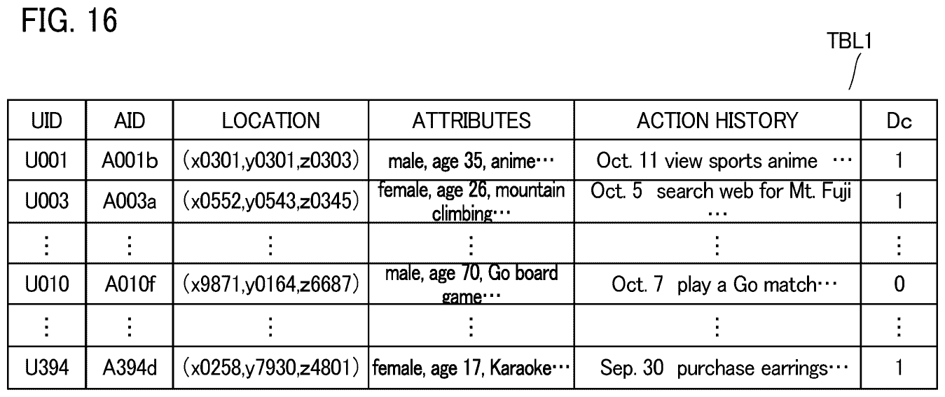

FIG. 16 is an explanatory diagram illustrating an example data structure of the first table TBL1 according to Modification 4. When the data of the control data Dc is “1”, it indicates that forced instantaneous transfer is allowed. On the other hand, when the data of the control data Dc is “0”, it indicates that forced instantaneous transfer is not allowed.

The specifier 114B according to the fourth modification specifies the interest of a yet-to-be-engaged avatar for which forced instantaneous transfer is allowed. According to Modification 4, the forced instantaneous transfer is performed in a case in which a yet-to-be-engaged avatar, for which a forced instantaneous transfer is allowed, performs the predetermined action. Therefore, usability of the virtual space service is enhanced for the user.

### 4: Other Matters

(1) In the foregoing embodiments, the storage device 12 and the storage device 22 are each described as comprising a ROM and a RAM, for example, but is a flexible disk, a magneto-optical disk (for example, a compact disc, a digital versatile disc, or a Blu-ray (registered trademark) disc), a smart card, a flash memory device (for example, a card, a stick, or a key drive), a compact disc-ROM (CD-ROM), a register, a removable disk, a hard disk, a floppy (registered trademark) disk, a magnetic strip, a database, a server, or another appropriate storage medium. A program may be transmitted from a network via an electric communication line. The programs may be transmitted from the communication network NW via the electronic communication line.

(2) In the foregoing embodiments, the information, signal, or the like may be expressed by using any of various different techniques. For example, data, an order, a command, information, a signal, a bit, a symbol, a chip, or the like that can be referred to throughout the description above may be expressed by using a voltage, a current, electromagnetic waves, a magnetic field, or a magnetized particle, an optical field or a photon, or any combination thereof.

(3) In the foregoing embodiments, information or the like that has been input or output may be stored in a specified place (for example, a memory), or may be managed by using a management table. The information or the like that has been input or output can undergo overwriting, updating, or postscripting. The information or the like that has been output may be deleted. The information or the like that has been input may be transmitted to another apparatus.

(4) In the foregoing embodiments, determination may be performed on the basis of a value (0 or 1) expressed by using one bit, may be performed on the basis of a Boolean value (true or false), or may be performed on the basis of a comparison between numerical values (for example, a comparison with a predetermined value).

(5) In a processing procedure, a sequence, a flowchart, or the like that has been described as an example in the embodiments described above, the order may be changed as long as there is no conflict. For example, in the method described in the present disclosure, various step elements have been provided by using an illustrative order, and the specified order that has been provided is not restrictive.

(6) The respective functions illustrated in FIGS. 1-16 are implemented by any combination of at least one of hardware and software. A method for implementing respective function blocks is not particularly limited. Stated another way, the respective function blocks may be implemented by using a single physically or logically coupled device, or may be implemented by directly or indirectly (for example, in a wired manner, in a wireless manner, or the like) connecting two or more devices that are physically or logically separated, and using these multiple devices. The function blocks may be implemented by a combination of the single device described above or the plural devices described above and software.

(7) The foregoing programs as an example in the embodiments described above are to be broadly construed as meaning an order, an order set, a code, a code segment, a program code, a program, a sub-program, a software module, an application, a software application, a software package, a routine, a sub-routine, an object, an executable file, an execution thread, a procedure, a function, or the like, regardless of whether the programs are referred to as software, firmware, middleware, a microcode, a hardware description language, or other term.

Software, an order, information, or the like may be transmitted or received via a transmission medium. For example, when software is transmitted from a website, a server, or another remote source by using at least one of a wired technique (a coaxial cable, an optical fiber cable, a twisted-pair wire, a digital subscriber line (DSL), or the like) or a wireless technique (infrared rays, microwaves, or the like), at least one of these wired and wireless techniques falls under the definition of the transmission medium.

(8) In each of the embodiments described above, the terms “system” and “network” are compatibly used.

(9) The information, the parameter, or the like that has been described in the present disclosure may be expressed by using an absolute value, may be expressed by using a value relative to a predetermined value, or may be expressed by using other corresponding information.

(10) In the foregoing embodiments, the user apparatuses 20[1] to 20[j] are a mobile station (MS) in some cases. In some cases, the mobile station is referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms by those skilled in the art. In the present disclosure, the terms “mobile station”, “user terminal”, “user equipment (UE)”, “terminal”, and the like can be compatibly used.

(11) In the foregoing embodiments, the terms “connected”, and “coupled”, or all transformations thereof mean all types of direct or indirect connection or coupling of two or more elements, and can include that one or more intermediate elements exist between two elements that are “connected” or “coupled” to each other. Coupling or connection of elements may be physical coupling or connection, logical coupling or connection, or a combination thereof. For example, “connection” may be replaced with “access”. In the case of use in the present disclosure, it can be considered that two elements are “connected” or “coupled” to each other by using at least one of one or more of electric wires, cables, and printed electrical connections, and by using electromagnetic energy or the like having wavelengths of, as some non-limiting and non-comprehensive examples, a wireless frequency range, a microwave region, and a light (both visible and invisible) region.

(12) In the foregoing embodiments, the description “on the basis of” does not mean “solely on the basis of” unless otherwise specified. In other words, the description “on the basis of” means both “solely on the basis of” and “at least on the basis of”.

(13) The term “determining” used in the present disclosure includes a variety of operations in some cases. The “determining” can include, for example, that “judging”, “calculating”, “computing”, “processing”, “deriving”, “investigating”, “looking up, search, or inquiry” (for example, looking up, search, or inquiry of a table, a database, or another data structure), ascertaining is considered as “determining”. The term “determining” can include, for example, that “receiving” (for example, receiving information), “transmitting” (for example, transmitting information), “input”, “output”, or “accessing” (for example, accessing data in a memory) is considered as “determining”. The term “determining” can include that “resolving”, “selecting”, “choosing”, “establishing”, “comparing”, or the like is considered as “determining”. Stated another way, “determining” can include that any kind of operation is considered as “determining”. The term “determining” may be replaced with “assuming”, “expecting”, “considering”, or the like.

(14) In the embodiments described above, in a case in which “include”, “including”, and modifications thereof are used, these terms are intended to be comprehensive in substantially the same manner as the term “comprising”. The term “or” used in the present disclosure is not intended to be the exclusive OR.

(15) In the present disclosure, for example, in a case in which an article, such as a, an, or the, is added, the present disclosure may include that the nouns that follow these articles are plural.

(16) In the present disclosure, the description “A and B are different” may mean “A and B are different from each other”. The description may mean “each of A and B is different from C”. The terms “separated”, “coupled”, and the like may be construed in substantially the same manner as “different”.

(17) Respective aspects and embodiments described in the present disclosure may be used individually, may be combined and used, or may be switched and used according to execution. A report of predetermined information (for example, a report of “X”) is not limited to a report that is explicitly made, and may be implicitly made (for example, without making a report of the predetermined information).

The present disclosure has been described in detail above, but it would be obvious to those skilled in the art that the present disclosure is not limited to the embodiments described in the present disclosure. The present disclosure can be implemented as alterations and modifications without departing from the spirit and scope of the present disclosure specified by the description of the claims. Accordingly, the description of the present disclosure has been provided for exemplary and explanatory purposes and is not restrictive of the present disclosure.

Description of Reference Signs

1 . . . virtual space system, 10A . . . virtual space server, 10B . . . virtual space server, 20[1]-
20[j] . . . user apparatus, 113 . . . detecting unit, 114A . . . specifier, 114B . . . specifier, 115A . . .
transferer, 115B . . . transferer, A1 . . . avatar, A2 . . . avatar, A3 . . . yet-to-be-engaged avatar,
TBL1 . . . first table, TBL2 . . . second table, TBL3 . . . third table, TBL4 . . . fourth table.

1. A virtual space management apparatus comprising:
a detector configured to detect a topic for each of a plurality of communities, each of which is formed through conversation of two or more avatars present in a virtual space;
a specifier configured to specify a destination community from among the plurality of communities, based on a degree of similarity between an interest of a yet-to-be-engaged avatar and the topic for each of the plurality of communities, wherein the yet-to-be-engaged avatar is an avatar that has not participated in any of the plurality of communities; and
a transferer configured to instantaneously transfer the yet-to-be-engaged avatar to an area where the yet-to-be-engaged avatar can converse with the two or more avatars belonging to the destination community.

2. The virtual space management apparatus according to claim 1, wherein:
the detector is configured to detect the topic based on content of the conversation among the two or more avatars belonging to each of the plurality of communities, and
the specifier is configured to specify the interest of the yet-to-be-engaged avatar based on an action history of the yet-to-be-engaged avatar, attributes of a user corresponding to the yet-to-be-engaged avatar, or both.

3. The virtual space management apparatus according to claim 1,
wherein the specifier is configured to:
present to the yet-to-be-engaged avatar a situation of a candidate community to which the yet-to-be-engaged avatar is to be instantaneously transferred, from among the plurality of communities, and
specify the candidate community as the destination community based on a permission from the yet-to-be-engaged avatar to participate in the candidate community.

4. The virtual space management apparatus according to claim 1, wherein the transferer is configured to instantaneously transfer the yet-to-be-engaged avatar to the destination community in response to a predetermined action by the yet-to-be-engaged avatar.

5. The virtual space management apparatus according to claim 1,
wherein the transferer is configured to:
measure time elapsed since the yet-to-be-engaged avatar started to participate in the destination community, and
instantaneously transfer the yet-to-be-engaged avatar from a first location within the area to a second location outside the area, in response to the elapsed time reaching a reference time length.
